(19) United States
(12) Patent Application Publication
(10) Pub. No.: US 2009/0039180 A1
(43) Pub. Date: Feb. 12, 2009

(54) MIXING CAP FOR SPRAY NOZZLE FOR PACKAGING MACHINE

(76) Inventors: Anthony John Lukasiewicz, Howell, MI (US); James Robert Basinger, New Hudson, MI (US)

Correspondence Address: WARN, HOFFMANN, MILLER & LALONE, .P.C, PO BOX 70098, ROCHESTER HILLS, MI, 48307, US

(21) Appl. No.: 11/834,836

(22) Filed: Aug. 7, 2007

(51) Int. Cl. B01F 3/04; B01F 3/00; B65B 5/02

(52) U.S. Cl. 239/418; 239/8; 53/558

(57) ABSTRACT

A packaging machine for forming, filling and sealing containers, which machine treats the containers with a liquid sterilizing agent before filling them, includes a nozzle assembly, with a mixing cap of a particular configuration, for helping to provide a sterilizing spray.

### BACKGROUND

(1) Field of the Invention

The present invention relates to a packaging machine and to a nozzle assembly and mixing cap for helping to provide a sterilizing spray. The invention is applicable to packaging machines and nozzle assemblies and mixing caps of various differing constructions and modes of operation.

(2) Description of Prior Art

An example of a packaging machine for forming, filling and sealing containers, which machine treats the containers with a bactericide before filling them, is disclosed in U.S. Pat. No. 3,566,575, which describes spraying the interior of an empty container with a bactericide. Containers of this type are used for liquid comestibles, such as milk and juice. The fogging system typically uses a dilute solution of hydrogen peroxide, which after spraying is irradiated with UV light to produce an antimicrobial effect on the internal surfaces of the container. The container is thereafter dried with air to remove the peroxide, before being filled.

### SUMMARY OF THE INVENTION

The invention relates to a nozzle assembly, including a mixing cap, for helping to provide the sterilizing spray, and to the cap itself, as well as to one or more various methods.

According to one aspect of the present invention, there is provided a mixing cap for a spray nozzle assembly for spraying a solution of a sterilant, the cap comprising:

a side wall and an end wall for partially defining a mixing chamber;

a primary passage extending through the end wall for directing a first portion of the solution out of the end wall; and

a plurality of secondary passages spaced about the primary passage for directing a second portion of the solution out of the end wall.

According to another aspect of the present invention, there is provided a mixing cap for a spray nozzle assembly for spraying a solution of a sterilant, the cap comprising:

a side wall and an end wall for partially defining a mixing chamber;

a tip projecting from the end wall; and

an outlet passage in the tip for directing the solution out of the end wall, the outlet passage being enlarged at its outer end.

According to another aspect of the present invention, there is provided a spray nozzle assembly for spraying a mixture of gas and sterilizing liquid, the nozzle assembly including a cap as aforesaid.

According to another aspect of the present invention, there is provided a packaging machine for forming, filling and sealing containers, which machine treats the containers with a solution of a sterilant before filling them, the machine comprising a nozzle assembly as aforesaid.

According to another aspect of the present invention, there is provided a method of spraying a solution of a sterilant from a nozzle assembly that includes a cap, the method comprising the steps of:

mixing gas under pressure and the solution in a mixing chamber in the cap to form the mixture;

directing a first portion of the mixture out of the cap through an outlet passage of the cap;

simultaneously directing a second portion of the mixture out of the cap through a plurality of side passages distributed around the outlet passage; and

controlling the gas pressure and the liquid solution flow rate in the cap to prevent excessive back pressure in the cap while enabling atomization of the liquid solution in the mixing chamber.

According to another aspect of the present invention, there is provided a method of spraying a solution of a sterilant into a container, comprising mixing the solution and gas so as to provide a mixture comprised of the gas and atomized the solution and spraying the mixture so as to provide a solid conical spray of the mixture rather than a hollow conical spray thereof.

### BRIEF DESCRIPTION OF THE DRAWINGS

In order that the invention may be clearly and complete disclosed, reference will now be made, by way of example, to the accompanying drawings, in which:

FIG. 1 is a schematic illustration of steps encompassed in the forming, treating, filling and sealing of containers as they pass through a packaging machine;

FIG. 2 is a side elevation of a nozzle assembly that forms part of the machine of FIG. 1 and that is used for spraying a sterilizing solution into the containers;

FIG. 3 is an enlarged axial sectional view of a downstream end portion of the nozzle assembly of FIG. 2, showing a liquid nozzle and a mixing cap;

FIG. 4 is a further enlarged, axial sectional view of the mixing cap of FIG. 3;

FIG. 5 is a yet further enlarged, axial sectional view of a tip portion of the mixing cap;

FIG. 6 is an underneath perspective view of the mixing cap;

FIG. 7 is a bottom plan view of the tip portion of the mixing cap; and

FIG. 8 is an enlarged sectional view of a portion of the mixing cap taken on the line 8 of FIG. 4.

### DETAILED DESCRIPTION

The drawings illustrate one embodiment of the invention that is a packaging machine 10 including a nozzle assembly 30 and a mixing cap 40.

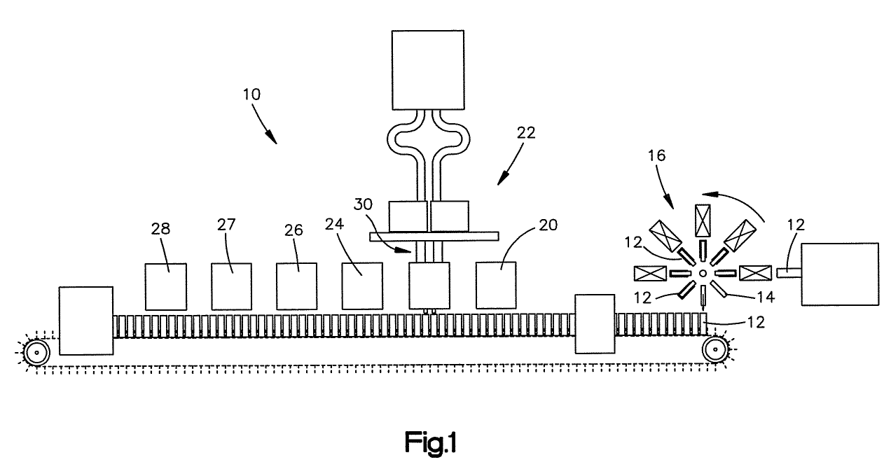

In operation of the packaging machine 10, flat container sleeves are opened and, as illustrated schematically in FIG. 1, are positioned as open-ended sleeves 12 on a multi-armed mandrel 14, which is a part of a rotary, bottom pre-breaking, folding and sealing unit 16. While a container sleeve 12 is on the mandrel 14, the bottom of the container is closed and sealed. The container is then stripped from the unit 16 into a horizontal endless chain conveyor when it reaches rotary index position adjacent the conveyor. The container 12 then passes to a top pre-breaker station 20, then on into a fogging station 22 where a sterilizing agent is sprayed onto the inside surface of the container, as described below in detail.

A drying station 24 removes residual sterilizing agent from the container 12. The container 12 then continues through the machine into a filling station 26 where the container is filled. The container 12 is passed on to a top closing unit 27 where top closing panels are folded inwards and thence to a top sealing station 28 where it is sealed so that it can be passed out of the end of the machine 10.

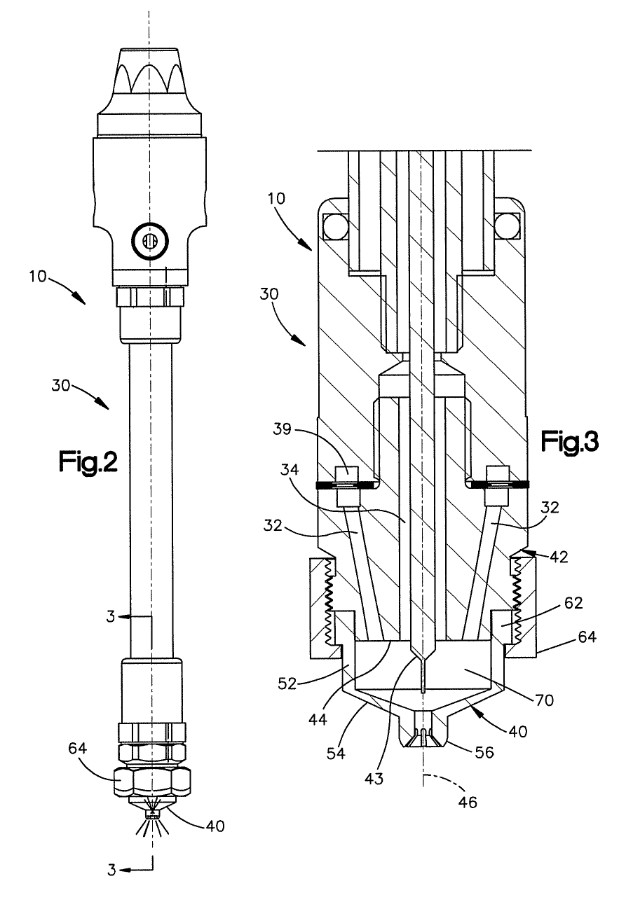

The spraying or fogging operation is accomplished by means of a nozzle assembly 30 (seen in more detail in FIGS. 2 and 3) that mixes air and liquid sterilizing agent and directs the mixture into the container. Various differing nozzle assemblies can be used. The air and the liquid are mixed in the nozzle assembly 30 prior to being sprayed into the container 12. Various sterilizing agents, such as alcohol, could be used as the liquid to be sprayed, although a 2% or 35% hydrogen peroxide solution is usable. Within the nozzle assembly, there are controlled, as discussed below, the parameters of liquid flow rate and air pressure. In addition, the fog has its path shaped and has a speed such that it reaches evenly to all portions of the inside surface of the container, including the bottom of the container.

The particular nozzle assembly 30 shown in FIGS. 1 through 3 includes a liquid nozzle 42 formed with at least one passage 32 for directing air from an annular chamber 39 to an air cap or mixing cap 40, and at least one passage 34 for directing liquid sterilizing agent to a location adjacent a needle tip 43. The liquid nozzle 42 has a round, or cylindrical, configuration that supports the mixing cap 40, as described below, and has an outer end face 44.

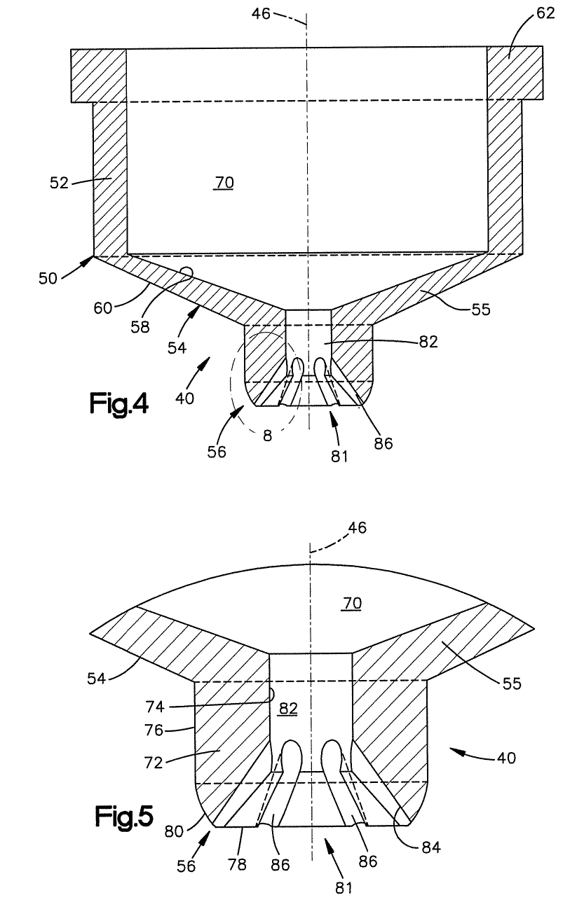

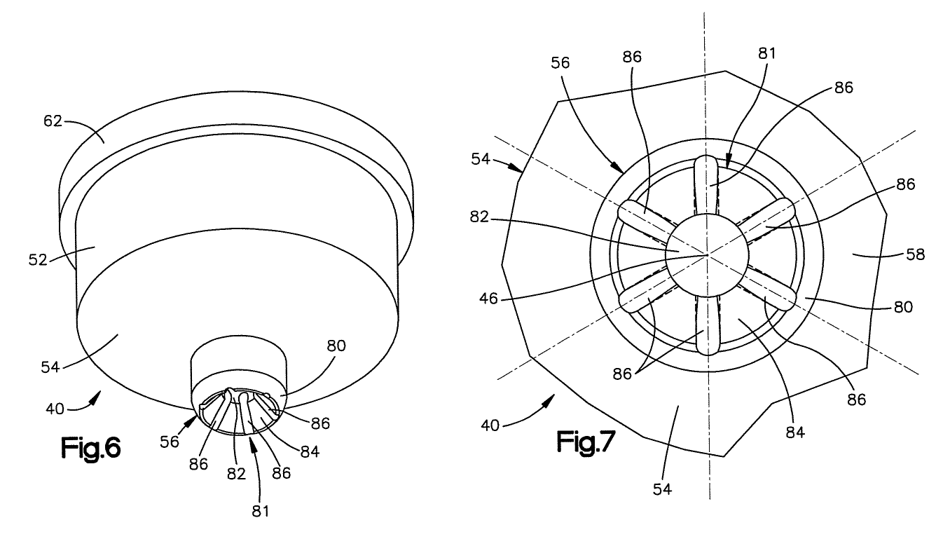

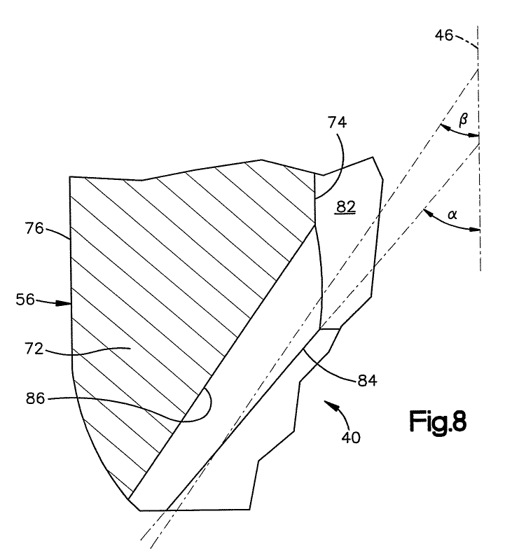

The mixing cap 40, as best seen in FIGS. 4-7, has a generally cylindrical configuration centered on an axis 46, adapted to fit onto the nozzle 42. As illustrated, the cap 40 is generally rotationally symmetrical about the axis 46; in other embodiments, that need not be the case.

The cap 40 has a main body portion 50. The main body portion includes a cylindrical, co-axially extending side wall 52. The side wall 52 extends co-axially outward on the nozzle assembly 30 from a location about at the outer end face 44 of the nozzle 42.

The main body portion 50 of the spray cap 40 also includes an end wall 54. the end wall 54 includes a frustoconical wall portion 55 that extends convergingly, co-axially outward from the side wall 52 to a tip portion 56 of the cap that is centered on the axis 46. The end wall portion 55 has an inner surface 58 and an outer surface 60.

A retaining flange 62 is provided at the upper end of the side wall 52 opposite from the end wall 54. As can be seen in FIG. 3, the flange 62 is adapted to be engaged by a retainer, for example in the form of a nut 64, to secure the cap 40 in position on the liquid nozzle assembly 42.

The cap side wall 52 and end 54 wall define, together with the nozzle 42, a mixing chamber 70. The liquid and the air are mixed in this chamber 70, as described below.

The end wall 54 has an outlet passage 81 (FIGS. 4-7) for directing fluids out of the mixing chamber 70. The outlet passage 81 includes a primary outlet passage 82 and a plurality of secondary outlet passages 86. In the illustrated embodiment, at least a portion of the outlet passage 81 is formed in a protruding or projecting tip portion or tip 56 that forms part of the end wall 54. In other embodiments, the outlet passage may be formed in an end wall that does not include a protruding or projecting tip.

Specifically, in the illustrated embodiment, the tip, or tip portion, 56 of the cap 40 projects axially from the frustoconical portion 55 of the end wall 54. The tip 56 has a generally cylindrical configuration centered on the axis 46. The tip 56 has a cylindrical wall 72 with parallel inner and outer side surfaces 74 and 76 centered on the axis 46. The wall 72 has an axially outer end surface 78 that forms a terminal end surface of the tip 56. The outer end surface 78 may be beveled or rounded, for example as shown at 80, where it meets the outer side surface 76.

The inner side surface 74 of the tip 56 defines the primary outlet passage 82 of the cap 40. In this embodiment the primary outlet passage 82 has a generally cylindrical configuration, and it is centered on the axis 46, thus forming a central outlet passage of the cap 40.

The tip 56 of the illustrated cap 40 has a chamfer 84 (FIGS. 5-8) that extends between the outer end surface 78 and the inner side surface 74. In the illustrated embodiment, the chamfer 84 has an 82° included angle centered on the axis 46, although other angles may be suitable. Thus, the chamfer surface 84 extends at an angle α (FIG. 8) of 41° from the axis 46. Because of the presence of the chamfer 84, the tip 56 is recessed axially toward the mixing chamber 70, and the central passage 82 is radially enlarged toward its axially outer end (see FIG. 5).

A plurality of secondary outlet passages 86 (FIGS. 5-8) are formed in the tip portion 56 of the cap 40. In the illustrated embodiment, there are six secondary outlet passages 86 in the form of slots. In other embodiments, the number, configuration and placement may differ.

In the illustrated embodiment, each one of the secondary outlet passages 86 has a cylindrical configuration interrupted by (intersecting) the chamfer 84 and may be formed either by (a) drilling a circular passage through the tip 56 of the cap 40 prior to formation of the chamfer, or by (b) removing a part-circular portion of material from the chamfered edge (and from the portion of the side wall 72 immediately inward) after formation of the chamfer, to form a slot. The secondary passages 86 may be spaced apart axially from the mixing chamber 70, as in the illustrated embodiment.

In the illustrated embodiment, for example, the secondary passages 86 are formed in about the outer one half of the tip 56. The passages may be formed by drilling with a cylindrical tool at an angle β (FIG. 8) of about 35° from the axis 46. The passages 86 are thus “steeper” than the chamfer 84.

In operation of the nozzle assembly, liquid flows through the liquid passage 34 and air under pressure flows through the air passages 32 in the nozzle assembly. The pressurized air, and the liquid, mix in the mixing chamber 70 of the mixing cap 40.

The dimensions of the mixing cap 40 are selected so that the liquid is atomized in the mixing chamber 70—that is, a fog is produced as the sterilizing agent is distributed from the cap. It is desirable that the sterilizing agent be sprayed as a mist or fog with very small droplets to coat better the internal surfaces of the container 12 with a proper amount of sterilant thereby to enhance interaction with the UV light, and to speed drying. It is also desirable that the droplets be evenly dispersed so that all areas of the internal surfaces of the container 12 can be covered evenly. (Alternatively, the cap 40 may be employed with a nozzle assembly for vaporizing liquid rather than atomizing it.)

It is believed that the relatively long (axial direction) side wall 52 of the mixing cap 40 provides for a mixing chamber 70 that is large enough to enable the desired atomization to occur. The volume of the mixing chamber 70 is large enough, in relation to the liquid inflow rate and the air inflow pressure on the one hand, and in relation to the outflow rate on the other hand, to minimize back pressure that could hinder the liquid from coming out of the liquid nozzle 42. Thus, a relatively high air pressure (45 psi, for example) can be maintained, which is helpful in providing a spray pattern that is well atomized and that sprays the needed distance.

The resulting fog path is conical in form, and is solidly (rather than hollowly) conical, to help reach all internal surfaces of the container 12 being sprayed. Because of the relatively high air pressure that can be used, the fog path has a speed such that it reaches all internal surface portions of the container 12, including the bottom. The cone angle for the solid conical spray is dependent on the configuration and dimensions of the container to be sprayed, as well as on the distance of the nozzle from the container.

The outlet passage 81, with its relatively long axial extent as compared to the cap side wall 52, is believed to provide sufficient length for the spray pattern to develop prior to being directed out of the mixing cap 40 completely.

It is believed that the presence of the primary outlet passage 82 provides for a fog path with sufficient volume and speed to reach all the internal surfaces of the container including the bottom. The chamfer 84 is believed to help provide the desired conical spray pattern.

It is believed that the presence of the secondary outlet passages 86 helps to reduce turbulence that may occur due to the circular nature of the primary outlet 82 and the presence of the chamfer 84. Specifically, it is believed that the flow through the secondary outlet passages 86 is faster than the flow through the primary outlet passage 82, because the secondary outlet passages are smaller in cross-sectional area than the primary outlet passage. This difference in flow rate might help to stabilize the flow pattern out of the outlet passage 81. Thus, the passages 86 act as flow concentration channels that help to control speed and direction of the flow to provide the desired distribution pattern.

The dimensions of the various portions and passages of the cap 40 can have an influence on the spray pattern, the degree of atomizing (fineness of the mist), depth of spray pattern obtained (for taller containers), etc. The dimensions of the mixing cap are selected to help implement a desired relationship between (a) air pressure (incoming), (b) liquid flow rate and pressure (incoming), (c) volume of the mixing chamber 70, (d) outlet flow area, and (e) droplet size. When these factors are properly controlled, the desired atomization occurs, back pressure is controlled, and the desired spray pattern and rate are provided.

Herewith are described the particular dimensions of one mixing cap 40 in accordance with the invention. Of course, these dimensions are not limiting, and other caps 40 in accordance with the invention will have other dimensions.

The cap side wall 52 has an outer diameter of 0.625 inches and an inner diameter of 0.526 inches. The side wall 52 has an axial length of 0.305 inches. The end wall 54 tapers at an angle of 25° from horizontal on its outer surface 60 and 20° from horizontal on its inner surface 58, and has an axial height (extent) of 0.102 inches.

The tip 56 has an outer diameter of 0.187 inches, an inner diameter (central passage 82) of 0.067 inches, and a length of 0.117 inches. Thus, the outer diameter of the tip 56 is about one third of the inner diameter of the cap side wall 52. The tip length is about equal to the length of the portion of the side wall 52 that extends between the liquid nozzle outer end face 44 and the end wall portion 55, as well as about equal to half of the length of the side wall.

The chamfer 84 is formed with an included angle of 82° and extends 0.44 inches inward from the outer end surface 78 of the tip 56. The slots 86 are each 0.019 inches in diameter, and extend at an angle of 55° to the axis 46.

In experiments, a known spray nozzle assembly was compared with the assembly described with reference to the drawings, which differed from the known assembly chiefly in having the mixing cap. Each nozzle assembly was mounted on a vertically reciprocated top pre-breaker of such a machine, and dove into the individual cartons during the experiments.

A clear plastics box in the configuration of the rectangular carton was used to evaluate visually a 2% peroxide solution spray coverage. The known nozzle assembly referred to above did not provide adequate coverage of 1.5 liter gable-top cartons used in the experiments, while residual levels of H₂O₂ were relatively high. However, the assembly described with reference to the drawings was found to give relatively even coverage of the wholes of the inside surfaces of the cartons.

Having described the invention, we claim:

1. A mixing cap for a spray nozzle assembly for spraying a solution of a sterilant, the cap comprising:
a side wall and an end wall for partially defining a mixing chamber;
a primary passage extending through the end wall for directing a first portion of the solution out of the end wall; and
a plurality of secondary passages spaced about the primary passage for directing a second portion of the solution out of the end wall.

2. A cap as set forth in claim 1 wherein the end wall includes a protruding tip through which the primary passage extends and the secondary passages are spaced apart in an annular array about the primary passage.

3. A cap as set forth in claim 1 wherein the secondary passages are slots in the surface of the primary passage.

4. A cap as set forth in claim 1 including a recess in the end wall whereby the outer end of the primary passage is enlarged.

5. A cap as set forth in claim 4 wherein the recess is formed by a chamfered surface on the end wall.

6. A cap as set forth in claim 5 wherein the secondary passages extend at an angle to the chamfered surface.

7. A cap as set forth in claim 1 wherein the primary passage opens from the mixing chamber and the secondary passages are spaced apart axially from the mixing chamber.

8. A cap as set forth in claim 1 wherein the length of the primary passage is about equal to the length of the side wall of the cap.

9. A mixing cap for a spray nozzle assembly for spraying a solution of a sterilant, the cap comprising:
a side wall and an end wall for partially defining a mixing chamber;
a tip projecting from the end wall; and
an outlet passage in the tip for directing the solution out of the end wall, the outlet passage being enlarged at its outer end.

10. A cap as set forth in claim 9 wherein the enlarged end of the outlet passage is formed by a chamfered surface on the tip.

11. A cap as set forth in claim 10 wherein the outlet passage comprises a primary outlet passage and a plurality of secondary outlet passages that are formed as recesses in the chamfered surface.

12. A cap as set forth in claim 11 wherein the primary outlet passage extends centrally through the tip and the secondary outlet passages are spaced apart in an annular array about the primary outlet passage.

13. A spray nozzle assembly for spraying a mixture of gas and sterilizing liquid, the nozzle assembly including a cap according to one of claims 1 or 9.

14. An assembly as in claim 13 including ducting for directing gas under pressure into the cap, and a liquid nozzle for directing liquid into the cap to be mixed with the gas to form the mixture, the mixing chamber being defined by the liquid nozzle, the end wall and the side wall.

15. An assembly as in claim 14 wherein the spacing between the liquid nozzle and the end wall is selected to provide the mixing chamber with a desired volume depending upon the gas pressure, the liquid flow rate, and the outlet flow area.

16. An assembly as in claim 13 wherein the end wall has a primary passage for directing a first portion of the solution out of the mixing chamber, and a plurality of secondary passages spaced about the primary passage for directing a second portion of the solution out of the mixing chamber.

17. A packaging machine for forming, filling and sealing containers, which machine treats the containers with a solution of a sterilant before filling them, said machine comprising a nozzle assembly according to claim 13 for treating containers with said solution.

18. A method of spraying a solution of a sterilant from a nozzle assembly that includes a cap, said method comprising the steps of:
mixing gas under pressure and said solution in a mixing chamber in the cap to form the mixture;
directing a first portion of the mixture out of the cap through an outlet passage of the cap;
simultaneously directing a second portion of the mixture out of the cap through a plurality of side passages distributed around the outlet passage; and
controlling the gas pressure and the liquid solution flow rate in the cap to prevent excessive back pressure in the cap while enabling atomization of the liquid solution in the mixing chamber.

19. A method as set forth in claim 17 wherein said step of directing a first portion of the mixture out of the cap through the outlet passage comprises laterally expanding the first portion of the mixture in a recessed outer end portion of the outlet passage.

20. A method as set forth in claim 19 wherein said step of laterally expanding the first portion of the mixture in a recessed outer end portion comprises gradually laterally expanding the first portion of the mixture in said outer end portion.

21. A method of spraying a solution of a sterilant into a container, comprising mixing said solution and gas so as to provide a mixture comprised of said gas and atomized said solution and spraying said mixture so as to provide a solid conical spray of said mixture rather than a hollow conical spray thereof.
